(19) United States
(12) Patent Application Publication
(10) Pub. No.: US 2026/0002785 A1
(43) Pub. Date: Jan. 1, 2026

(54) INTELLIGENT TRIP COORDINATOR

(71) Applicant: American Express Travel Related Services Company, Inc., New York, NY (US)

(72) Inventors: John C. Gale, Newburgh, NY (US); Justin R. Pastor, Newburgh, NY (US); John E. Dupnik, Phoenix, AZ (US); Manish Gupta, New York, NY (US); Cristian Corrales Valle, Phoenix, AZ (US)

(21) Appl. No.: 18/758,364

(22) Filed: Jun. 28, 2024

(51) Int. Cl. G01C 21/34

(52) U.S. Cl. CPC G01C 21/343

(57) ABSTRACT

Disclosed are various embodiments for an intelligent trip coordinator. A trip entry associated with a user can be received by a computing device, where the trip entry includes trip data. The computing device can generate a trip record based at least in part on the trip entry, where the trip record includes the trip data. Next, the computing device can send the trip record to an approval service. In response to receiving an approval from the approval service, the computing device can forward the trip record to a booking service. Finally, the computing device modifies the trip record based at least in part on booking data provided by the booking service.

### BACKGROUND

Organizing a trip within a corporation or other entity can include many complications. There can be several internal and external policies and regulations with which to comply, requiring a detailed record of data. In addition, there are numerous steps to organizing a trip from start to finish, many of which require coordination with different departments within the organization. Management of the coordination between each department, while maintaining an easily-accessible and complete record, is often difficult and error-prone.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of a network environment according to various embodiments of the present disclosure.

FIGS. 2A and 2B are flowcharts illustrating one example of functionality implemented as portions of an application executed in a computing environment in the network environment of FIG. 1 according to various embodiments of the present disclosure.

FIG. 3 is a sequence diagram illustrating one example of the interactions between the components of the network environment of FIG. 1 according to various embodiments of the present disclosure.

FIG. 4 is a sequence diagram illustrating one example of the interactions between the components of the network environment of FIG. 1 according to various embodiments of the present disclosure.

FIGS. 5A-5C are pictorial diagrams of example user interfaces rendered by a client device according to various embodiments of the present disclosure.

### DETAILED DESCRIPTION

Disclosed are various approaches for implementing an intelligent trip coordinator. Often, when organizing a trip within a corporation or other entity, there can be many internal and external policies and regulations with which to comply. For example, if a corporate executive wishes to use corporate resources for a trip, the corporation must collect certain information for regulatory reporting compliance. In addition, there can be numerous steps to organizing a trip from start to finish, many of which require coordination with different departments within the organization. Management of the coordination between each department, while maintaining an easily-accessible and complete record, is often difficult and error-prone.

For example, many businesses and organizations currently have disconnected systems for managing private aircraft and providing flights and other travel arrangements for executives. In some instances, a trip request is made via email to a manager of an aviation department, or via phone call to said manager. Additionally, often the workflow following a trip request (e.g., the approval process, the scheduling process, etc.) is similarly conducted through unofficial means. The process of collecting information and delegating tasks over these channels is susceptible to information loss. Moreover, these processes may leave an insufficient record for auditing and reporting purposes.

Accordingly, various embodiments of the present disclosure relate to a central intelligent trip coordinator for consolidation of data, management of communications, and automated delegation of various tasks to the appropriate department. The trip coordinator can serve as a single application which can integrate the various workflows and processes involved in arranging a trip for an organization while maintaining integrity of the record.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principles disclosed by the following illustrative examples.

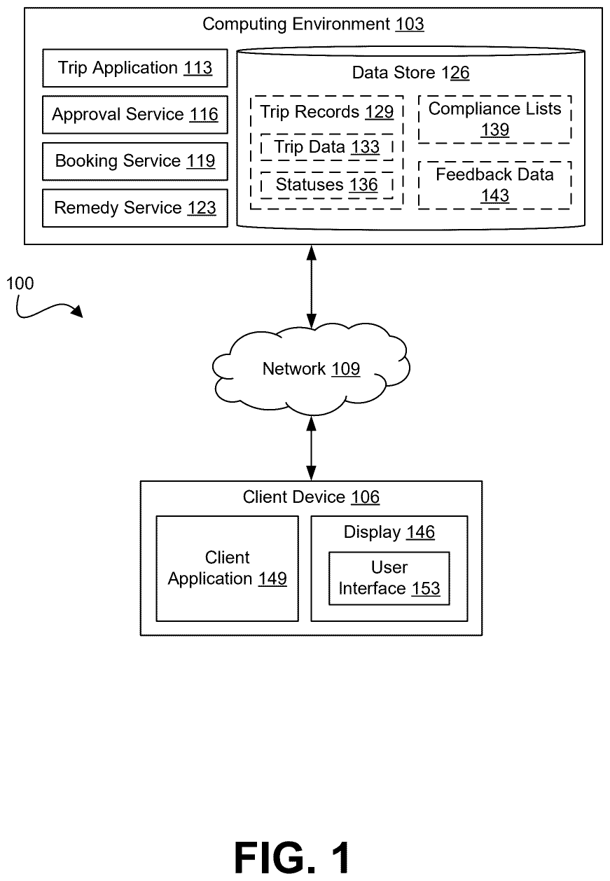

With reference to FIG. 1, shown is a network environment 100 according to various embodiments. The network environment 100 can include a computing environment 103 and a client device 106, which can be in data communication with each other via a network 109.

The network 109 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 109 can also include a combination of two or more networks 109. Examples of networks 109 can include the Internet, intranets, extranets, virtual private networks (VPNs), and similar networks.

The computing environment 103 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the computing environment 103 can employ a plurality of computing devices that can be arranged in one or more server banks or computer banks or other arrangements. Such computing devices can be located in a single installation or can be distributed among many different geographical locations. For example, the computing environment 103 can include a plurality of computing devices that together can include a hosted computing resource, a grid computing resource or any other distributed computing arrangement. In some cases, the computing environment 103 can correspond to an elastic computing resource where the allotted capacity of processing, network, storage, or other computing-related resources can vary over time.

Various applications or other functionality can be executed in the computing environment 103. The components executed on the computing environment 103 can include a trip application 113, an approval service 116, a booking service 119, a remedy service 123, and other applications, services, processes, systems, engines, or functionality not discussed in detail herein.

The trip application 113 can be executed to facilitate intelligent data collection and communications between users and various services. For example, the trip application 113 can serve as a central hub for communications between a client device 106 and the various services for approving and booking a trip entry. The trip application 113 can receive a trip entry, determine whether additional information is needed in order to satisfy various regulatory compliance requirements, and collect the additional information for consolidation in a single record, such as a trip record 129. The trip application 113 can interact with the approval service 116 to get a trip entry approved. Similarly, the trip application 113 can interact with a booking service 119 to determine travel arrangements and various other trip details. In addition, the trip application 113 can be used to gather feedback from a user through communications with a client device 106, interpret the feedback received, and if necessary, forward the feedback along to an appropriate remedy service 123. According to various examples, the trip application 113 can additionally provide various resources for the user, such as hotel lists, restaurant recommendations, vendor lists, or other useful resources to assist a user in planning their trip. In some examples, the trip application 113 can provide these resources based at least in part on data provided by the user.

The approval service 116 can be executed to receive, process, and approve or deny trip requests. For example, the approval service 116 can receive trip entries or trip records 129 from the trip application 113. The approval service 116 can then analyze the data included with the trip entry or record and determine whether the trip meets various approval requirements. In some embodiments, the approval service 116 can generate a message to send to an approval entity, such as, for example, generating and sending an email to a manager. In such cases, the approval service 116 can receive an approval or denial message from the approval entity (e.g., an approval or denial email from a manager), and determine approval or denial based at least in part on that message. Once approval or denial has been determined, the approval service 116 can communicate the results with other services and applications.

The booking service 119 can be executed to coordinate and secure travel arrangements once a trip has been approved. For example, the booking service 119 can find and book an aircraft for a flight as well as a pilot and a crew. This can be accomplished by the booking service 119 coordinating various schedules for each element of the trip. Once the booking service 119 has determined the details of the travel arrangements, the booking service 119 can send this information back to the trip application 113 for inclusion in the record.

The remedy service 123 can be representative of a variety of services which can resolve issues with the trip. The remedy service 123 can be executed to receive feedback data regarding the trip and determine a corresponding resolution. For example, if the feedback is related to a maintenance issue, the remedy service 123 can be representative of a maintenance service which can determine an appropriate maintenance solution corresponding to the feedback and delegate the solution to a maintenance team. In another example, where the feedback is regarding a technological issue experience with an aspect of the trip, the remedy service 123 can be representative of an information technology (IT) service which can determine and implement an appropriate IT resolution.

Also, various data is stored in a data store 126 that is accessible to the computing environment 103. The data store 126 can be representative of a plurality of data stores 126, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the data store 126 is associated with the operation of the various applications or functional entities described below. This data can include trip records 129 having trip data 133 and statuses 136, compliance lists 139, feedback data 143, and potentially other data.

The trip records 129 can be representative of one or more records or files containing various information about a trip. A trip record 129 can provide an easily accessible collection of data about a trip which can be used for internal and external audits, for communication with a client or user, as well as for other business purposes. Each trip record 129 can include trip data 133 and a status 136 for the trip.

The trip data 133 can represent information about a trip. The trip data 133 is associated with the trip record 129. Trip data 133 can include information such as, for example, who is taking the trip, the dates of the trip, the destination as well as stops along the way, transportation, the purpose of the trip, and potentially other information. The trip data 133 can also include booking details such as, for example, the specific plane which will be used for a flight, as well as the pilot, crew, etc.

Statuses 136 can be representative of a label or identifier for a trip record 129, where the status can represent the stage of the trip record. For example, after a trip record 129 has been created, the trip record 129 can have the status 136 of “pending.” Once a trip record 129 has been approved by the approval service 116, the status 136 can be updated to “approved.” Similarly, various activities and modifications to the trip record 129 can impact the status 136 of the trip record 129 and result in a new status 136 such as “pending,” “approved,” “awaiting booking,” “booked,” “in progress,” “completed,” etc. In some cases, the status 136 can be updated automatically with a change to the trip record 129.

The compliance lists 139 can be representative of a checklist or reference list of requirements for compliance with internal policies and/or external regulations. For example, a compliance list 139 can include the legal requirements for reporting travel expenses under applicable law or regulation. Similarly, a compliance list 139 can include requirements for authorizing trips under internal organizational policies. A compliance list 139 can be used by the services and applications in the computing environment 103 to enhance the data collection process, by providing a reference to determine what data is necessary for compliance with relevant policies, regulations, and laws.

Feedback data 143 can be representative of comments, reports, suggestions, notices, or other submissions from a user regarding their trip experience. For example, a traveler can submit a feedback response which details the events of their trip experience, such as any issues with crew, information technology, the plane or other vehicle, etc. The feedback data 143 can be extracted from the feedback response and can include key words (e.g., “plane,” “seat,” “Wi-Fi,” “crew,” etc.) which can be associated with a particular remedy service 123.

The client device 106 is representative of a plurality of client devices that can be coupled to the network 109. The client device 106 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The client device 106 can include one or more displays 146, such as liquid crystal displays (LCDs), gas plasma-based flat panel displays, organic light emitting diode (OLED) displays, electrophoretic ink (“E-ink”) displays, projectors, or other types of display devices. In some instances, the display 146 can be a component of the client device 106 or can be connected to the client device 106 through a wired or wireless connection.

The client device 106 can be configured to execute various applications such as a client application 149 or other applications. The client application 149 can be executed in a client device 106 to access network content served up by the computing environment 103 or other servers, thereby rendering a user interface 153 on the display 146. To this end, the client application 149 can include a browser, a dedicated application, or other executable, and the user interface 153 can include a network page, an application screen, or other user mechanism for obtaining user input. In some embodiments, the client application 149 can be executed to facilitate communications between a user and the trip application 113, such as receiving user inputs and sending the inputs to the trip application 113. The client device 106 can be configured to execute applications beyond the client application 149 such as email applications, social networking applications, word processors, spreadsheets, or other applications.

Next, a general description of the operation of the various components of the network environment 100 is provided. To begin, a user can initiate a trip entry or trip request via a client application 149 on a client device 106. The trip application 113 can work with the client application 149 to obtain all the information necessary to process the trip request. For example, the trip application 113 can reference the compliance lists 139 in order to request information from the client application 149. Next, the trip application 113 can send a trip record 129 generated from the trip request to an approval service 116. The approval service 116 can process the trip record 129 and determine whether to approve or deny the trip. Once the approval service 116 has approved a trip record 129, the trip application 113 can alert a user by sending a notification to a client application 149. Next the trip application 113 can send the trip record 129 to a booking service 119. The booking service 119 can receive the trip record 129 and determine the finer details and specifics on travel arrangements, bookings, staffing, and other aspects necessary for making a trip possible. The booking service 119 can return the booking data to the trip application 113 for modification of the trip record 129.

The trip application 113 can determine a departure date and a return date from the trip record 129 and use these dates for future communications with the user via a client application 149. For example, the trip application 113 can use the departure date to determine when to send a “ready-to-fly” checklist to the client application 149. Additionally, the trip application 113 can use the arrival date to determine when to request trip feedback from the client application 149. Once the trip application 113 receives feedback, the trip application 113 can identify a remedy service 123 and forward the feedback to the remedy service 123.

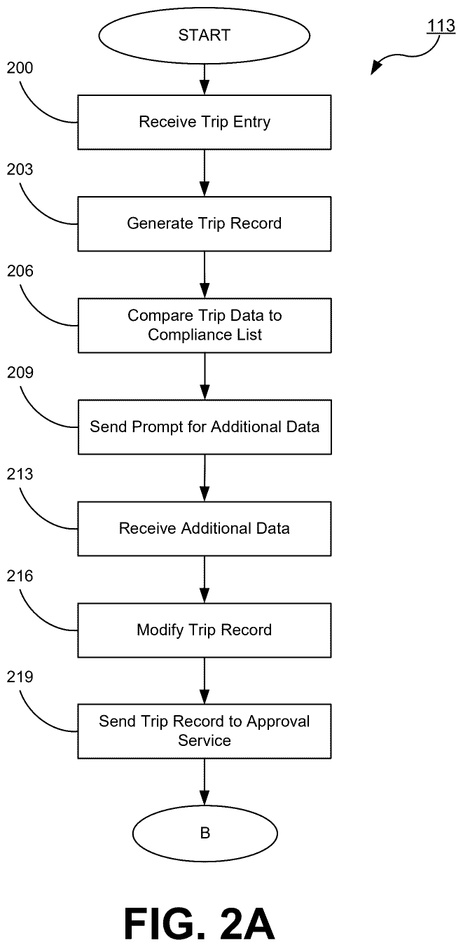

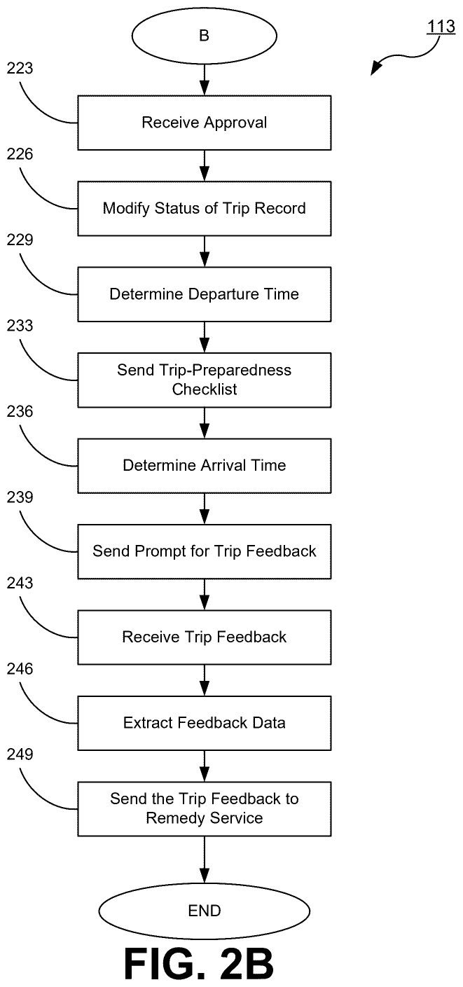

Referring next to FIGS. 2A and 2B, shown is a flowchart that provides one example of the operation of a portion of the trip application 113. The flowchart of FIGS. 2A and 2B provides merely an example of the many different types of functional arrangements that can be employed to implement the operation of the depicted portion of the trip application 113. As an alternative, the flowchart of FIGS. 2A and 2B can be viewed as depicting an example of elements of a method implemented within the network environment 100.

Beginning with block 200, the trip application 113 can be executed to receive a trip entry, or trip request. A trip entry can be representative of a request to initiate a trip or a submission of a new trip to the trip application 113. The trip entry can comprise initial trip data 133, such as the identity of the submitter, the traveler(s), the date(s), and/or the destination(s). In some examples, the trip application 113 can receive the trip entry from a client application 149 or other system, service, or application in the network environment 100.

At block 203, the trip application 113 can be executed to generate a trip record 129. In some cases, the trip application 113 can generate a trip recording corresponding to the trip entry received at block 200. The trip application 113 can use trip data 133 from the trip entry to generate the trip record 129. The trip application 113 can save the trip record 129 to a data store 126 or send the trip record 129 to another system, service, or application within the network environment 100.

Next, at block 206, the trip application 113 can be executed to compare the trip data 133 to a compliance list 139. The trip application 113 can use trip data 133 from the trip entry received at block 200, or trip data 133 associated with the trip record 129 generated at block 203 to compare to one or more compliance lists 139. The trip application 113 can retrieve relevant compliance lists 139 based at least in part on the trip data 133. For example, if the trip data 133 includes a destination of a particular country, the trip application 113 can obtain a compliance list 139 corresponding to the destination country. The compliance lists 139 can be obtained from a data store 126 or other system, service, or application in the network environment 100. The trip application 113 can compare the trip data 133 to the compliance list 139 to determine whether additional data is needed to meet the requirements in the compliance list 139.

At block 209, the trip application 113 can be executed to send a prompt for additional data. If the trip application 113 determines that additional data is needed based at least in part on the comparison of the trip data 133 with the compliance list 139, then the trip application 113 can generate a prompt and send the prompt to a client application 149. In some examples, the trip application 113 can send the prompt for additional data based at least in part on the trip entry received at block 200. In some examples, the trip application 113 can obtain a prompt message from a data store 126 based at least in part on the comparison of the trip data 133 with the compliance list 139. In some embodiments, when the trip application 113 determines that no additional data is needed based at least in part on the comparison of the trip data 133 to the compliance list 139, the trip application 113 can skip this block.

Next, at block 213, the trip application 113 can receive additional data. The trip application 113 can receive additional trip data 133, or other data, based at least in part on the prompt for additional data sent at block 209. In some examples, the additional data is received from a client application 149, or other system, service, or application in the network environment 100.

At block 216, the trip application 113 can modify the trip record 129. In some examples, the trip application 113 can modify the trip record 129 generated at block 203 with the additional data received at block 213. The trip application 113 can modify the trip record 129 based at least in part on the comparison of the trip data 133 to the compliance list 139 at block 206. In some embodiments, the trip application 113 can automatically update the trip record 129 with the additional data received at block 213. According to various examples, the trip application 113 can save the modified trip record 129 to a data store 126.

Next, at block 219, the trip application 113 can send the trip record 129 to an approval service 116. The trip application 113 can send the trip record 129 after it has been modified at block 216 to include the additional data received at block 213. The trip application 113 can send the trip record 129 to an approval service 116 based at least on a comparison of the trip data 133 with the compliance list 139. For example, once the trip application 113 has determined that all necessary data has been received in order to comply with the requirements in the compliance list 139, the trip application 113 can then send the trip record 129 containing all required data to the approval service 116 for approval.

Moving now to FIG. 2B, at block 223, the trip application 113 can be executed to receive approval. Once the trip application 113 has sent the trip record 129 to the approval service 116 at block 219, the trip application 113 can receive an approval in response. The trip application 113 can receive the approval from the approval service 116. In some examples, the trip application 113 receives a denial of the trip entry from the approval service 116 instead of an approval. In some examples, the trip application 113 can send the approval or denial to a client application 149.

Next, at block 226, the trip application 113 can modify the status 136 of the trip record 129. Once the trip application 113 has received approval (or denial, in some cases), the trip application 113 can update the status 136 of the trip record 129 to reflect the approval. For example, the trip application 113 can change a status 136 from “pending” to “approved” based at least in part on the approval received at block 223. The trip application 113 can save the modified status 136 of the trip record 129 to a data store 126 or send the modified status 136 to a client application 149 or other system, service, or application in the network environment 100.

At block 229, the trip application 113 can determine a departure time. The departure time can represent a date or time on which the traveler begins the journey associated with a trip entry. In some examples, the trip application 113 can determine a departure time based at least in part on the trip record 129. For example, the trip application 113 can identify the departure time from the trip data 133 of the trip record 129. Once a trip entry has been approved at block 223, the trip application 113 can determine the departure time in order to provide the traveler important information at a relevant time.

At block 233, the trip application 113 can be executed to send a trip-preparedness checklist. A trip-preparedness checklist can comprise a variety of pre-travel tasks, questions, or confirmations for a user to complete before embarking on their trip. For example, a trip-preparedness checklist can include questions about the user's passport expiration date, whether the user has had any recommended or required vaccinations based on the travel destination, whether the user has had any flu-like symptoms leading up to the departure date, or other pre-travel related inquiries. The trip application 113 can send the trip-preparedness checklist to a client application 149 associated with the traveler based at least in part on the trip record 129. For example, the trip application 113 can identify the traveler(s) associated with a trip record 129 based at least in part on the trip data 133 and determine a client application 149 associated with each traveler. Then, the trip application 113 can send the trip-preparedness checklist before the departure date determined at block 229.

Then, at block 236, the trip application 113 can determine an arrival time. The arrival time can represent a date or time on which the traveler completes the journey associated with a trip entry. In some examples, multiple arrival times can be associated with a trip record 129 as one complete trip may include a variety of stops. In some examples, the trip application 113 can determine an arrival time based at least in part on the trip record 129. For example, the trip application 113 can identify the arrival time from the trip data 133 of the trip record 129. Once a trip entry has been approved at block 223, the trip application 113 can determine the arrival time in order to provide the traveler important information at a relevant time.

At block 239, the trip application 113 can be executed to send a prompt for trip feedback. After determining the arrival time at block 236, the trip application 113 can automatically send a prompt for trip feedback to a client application 149 associated with the traveler after the arrival time has passed. In some examples, the trip application 113 can send the prompt for trip feedback based at least in part on the trip record 129. The trip application 113 can generate a prompt for trip feedback based at least in part on the trip record 129. In some examples, the trip application 113 can obtain the prompt from a data store 126 and customize the prompt based at least in part on the trip record 129 before sending it. In some embodiments, the trip application 113 can send the prompt for trip feedback to a client application 149 associated with each traveler identified in the trip record 129.

Next, at block 243, the trip application 113 can be executed to receive trip feedback. Trip feedback can comprise a submission from a user through a client application 149 which includes feedback data 143. The trip application 113 can receive the trip feedback from a client application 149 or other system, service, or application in the network environment 100. In some examples, the trip application 113 can receive the trip feedback in response to having sent the prompt for trip feedback at block 239.

At block 246, the trip application 113 can be executed to extract feedback data 143. After the trip application 113 has received the trip feedback at block 243, the trip application 113 can use various data extraction or data processing techniques to extract feedback data 143 from the trip feedback submission. For example, when the trip feedback is submitted in a text format, the trip application 113 can use language processing and analysis techniques to extract a meaning from the submission. The feedback data 143 can be representative of the resultant meaning of the text.

At block 249, the trip application 113 can be executed to send the trip feedback to a remedy service 123. In some examples, the trip application 113 can interpret the feedback data 143 extracted at block 246 in order to determine which remedy service, if any, should receive the trip feedback. For example, if the trip application 113 analyzes the feedback data 143 and determines that there was an issue with the Wi-Fi, the trip application 113 can forward the trip feedback to an Information Technology (IT) service. In another example, if the trip application 113 analyzes the feedback data 143 and determines that there was an issue with a chair on a plane, the trip application 113 can forward the trip feedback to a Maintenance service. After block 249, the flowchart of FIG. 2 comes to an end.

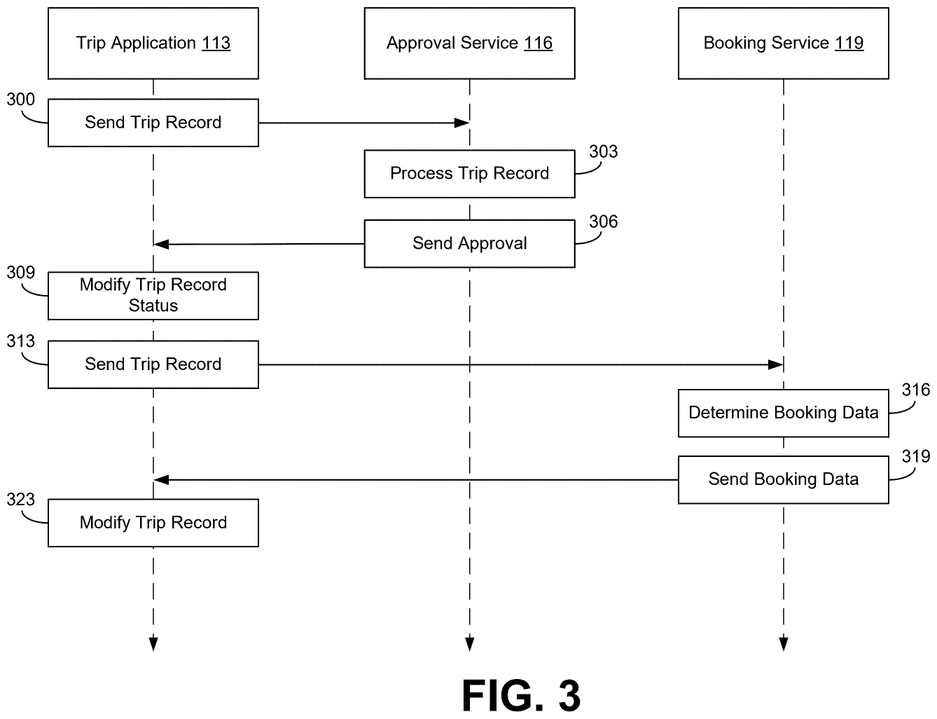

Moving next to FIG. 3, shown is a sequence diagram that provides one example of the interactions between the trip application 113, the approval service 116, and the booking service 119. The sequence diagram of FIG. 3 provides merely an example of the many different types of potential interactions between the trip application 113, the approval service 116, and the booking service 119. As an alternative, the sequence diagram of FIG. 3 can be viewed as depicting an example of elements of a method implemented within the network environment 100.

At block 300, the trip application 113 can be executed to send the trip record 129 to an approval service 116. The trip application 113 can send the trip record 129 to an approval service 116 based at least in part on a completion of the trip record 129. For example, as discussed at block 219, the trip application 113 can send the trip record 129 to the approval service 116 after the trip application 113 has determined that the trip record 129 includes all trip data 133 necessary to satisfy the requirements of a compliance checklist 139. In some examples, the trip application 113 can send the trip record 129 to the approval service 116 based at least in part on the submission and receipt of a trip entry.

Next, at block 303, the approval service 116 can process the trip record 129. After receiving the trip record 129 from the trip application 113 at block 300, the approval service 116 can process the trip record 129 to determine whether to approve or deny the trip record 129 and associated trip entry. In some examples, processing the trip record 129 comprises determining an approval entity (such as, for example, a manager, supervisor, or other authoritative agent) and sending the trip record 129 to the approval entity for approval. In some examples, the approval service 116 compares the trip record 129 received at block 300 to one or more compliance lists 139. The approval service 116 can determine whether or not all required trip data 133 is present within the trip record 129 and determine whether the trip data 133 satisfies various criteria for approval.

At block 306, the approval service 116 can be executed to send approval. After processing the trip record 129 at block 303, the approval service 116 can determine whether to approve or deny the trip record 129. The approval service 116 can send this approval or denial back to the trip application 113. In some embodiments, the approval can be representative of a message or notification that the trip record 129 has been approved. Similarly, in some examples, the approval service 116 can send a message or notification that the trip record 129 has been denied. In some situations where the approval service denies a trip record 129, the approval service 116 can include an explanation of the denial in the notification or message sent to the trip application 113.

Moving to block 309, the trip application 113 can modify the status 136 of the trip record 129. After the trip application 113 has received the approval from the approval service 116, or in some cases, the denial, the trip application 113 can modify the status 136 of the trip record 129 based at least in part on the approval or denial. For example, the trip application 113 can change the status 136 of a trip record 129 from “pending” to “approved” based at least in part on receiving approval from the approval service 116 at block 306. In some embodiments, the trip application 113 can notify a client application 149 of the modified status 136 of the trip record 129.

Next, at block 313, the trip application 113 can send the trip record 129 to a booking service 119. The trip application 113 can send the trip record 129 to the booking service 119 once the trip application 113 has received approval from the approval service 116 at block 306. An approved trip record 129 can be sent to the booking service 119 in order to finalize trip details. In some examples, the trip application 113 can send the trip record 129 to the booking service 119 based at least in part on the modified status 136 of the trip record 129 from block 309.

Next, at block 316, the booking service 119 can determine booking data. The booking service 119 can determine the booking data based at least in part on the trip record 129. Booking data can be representative of details surrounding a trip such as the specific vehicle to be used for transportation, the driver/pilot of the vehicle, any necessary crew or support staff, the detailed itinerary, and other points of trip data 133 which were not included in the trip record 129. The booking service 119 can have access to a variety of data stores 126 or other sources of data related to the booking data. The booking service 119 can determine the booking data based at least in part on this variety of other data. For example, if the trip entry includes a flight, the booking service 119 can access flight records for planes, pilots, and crews who are available during the required flight period and who have not surpassed their maximum flight hours in the preceding time period.

At block 319, the booking service 119 can send the booking data to the trip application 113. In some examples, the booking service 119 can send the booking data after it has been determined at block 316. The booking service 119 can send the booking data to the trip application 113 in response to receiving the trip record 129 at block 313.

Next, at block 323, the trip application 113 can modify the trip record 129. Once the trip application 113 receives the booking data from the booking service 119 at block 319, the trip application 113 can modify the trip record 129. The trip application 113 can modify the trip record 129 based at least in part on the booking data received at block 319. In some examples, the trip application 113 modifies the trip record 129 by updating the trip data 133 to include the booking data received at block 319. In some examples, the trip application 113 can modify the status 136 of the trip record 129 based at least in part on the booking data received at block 319. For example, the trip application 113 can change the status 136 of the trip record 129 from “approved” to “booked” or some other status indicator. In such examples, the trip application 113 can send a notification or message to a client application 149 associated with the trip requestor or the associated traveler. After block 323, the sequence diagram of FIG. 3 comes to an end.

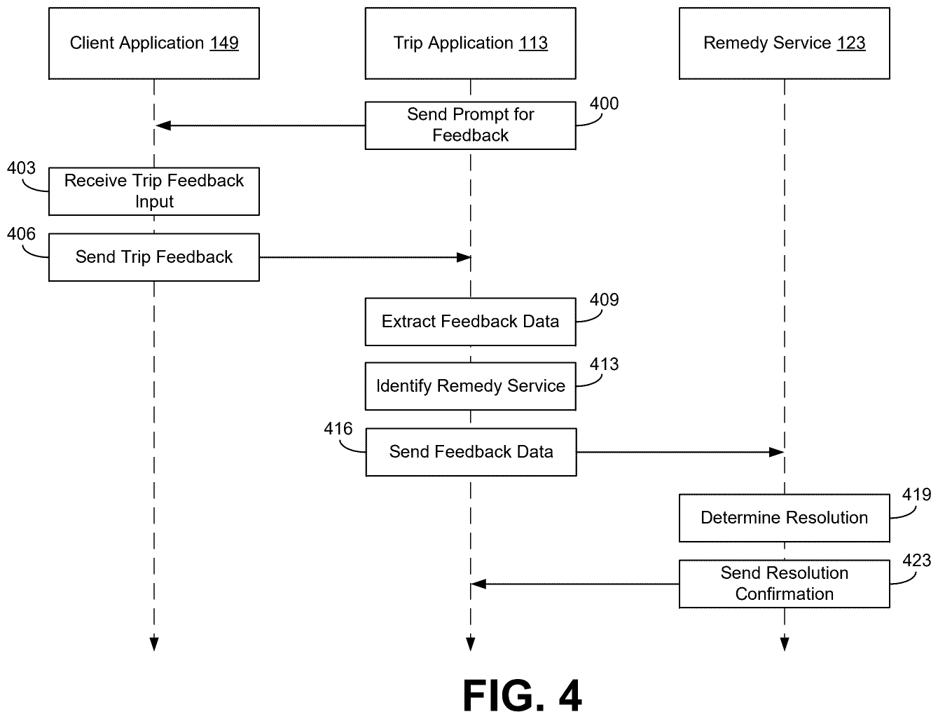

Turning to FIG. 4, shown is a sequence diagram that provides one example of the interactions between the client application 149, trip application 113, and the remedy service 123. The sequence diagram of FIG. 4 provides merely an example of the many different types of potential interactions between the client application 149, trip application 113, and the remedy service 123. As an alternative, the sequence diagram of FIG. 4 can be viewed as depicting an example of elements of a method implemented within the network environment 100.

Beginning with block 400, the trip application 113 can send a prompt for feedback to the client application 149. As described in the discussion of block 239 of FIG. 2B, the trip application 113 can send a prompt for trip feedback after determining the arrival time associated with a trip record 129. The trip application 113 can automatically send a prompt for trip feedback to the client application 149 associated with a traveler after the arrival time has passed. The trip application 113 can generate a prompt for trip feedback based at least in part on the trip record 129. In some examples, the trip application 113 can send the prompt for trip feedback based at least in part on the trip record 129. In some examples, the trip application 113 can obtain the prompt from a data store 126 and customize the prompt based at least in part on the trip record 129 before sending it. In some embodiments, the trip application 113 can send the prompt for trip feedback to a client application 149 associated with each traveler identified in the trip record 129.

Moving to block 403, the client application 149 can be executed to receive trip feedback input. After the client application 149 receives the prompt for trip feedback at block 400, the client application 149 can forward the prompt or send another notification, message, or alert to the user via a user interface 153. The client application 149 can receive the user input of the trip feedback in response to having notified the user. For example, the client application 149 can receive trip feedback input from the user through a user interface 153 or other source in response to having notified the user.

Next, at block 406, the client application 149 can send the trip feedback to the trip application 113. After the client application 149 has received the trip feedback input from the user, the client application 149 can send the trip feedback to the trip application 113 for further processing. In some examples, the client application 149 can send the trip feedback to a remedy service 123, a data store 126, or other system, service, or application within the network environment 100.

Moving to block 409, the trip application 113 can extract feedback data 143. The trip application 113 can extract feedback data 143 from the trip feedback received from the client application 149 at block 406. As described in the discussion of block 246 of FIG. 2B, after the trip application 113 has received the trip feedback at block 406, the trip application 113 can use various data extraction or data processing techniques to extract feedback data 143 from the trip feedback submission. For example, when the trip feedback is submitted in a text format, the trip application 113 can use language processing and analysis techniques to extract a meaning from the submission. The feedback data 143 can be representative of the resultant meaning of the text.

Next, at block 413, the trip application 113 can be executed to identify a remedy service 123. In some examples, the trip application 113 can identify a remedy service 123 based at least in part on the feedback data 143 extracted at block 409. The trip application 113 can use the feedback data 143 to determine the nature of the issue and the appropriate remedy service 123 which corresponds to the nature of the issue. For example, the trip application 113 can use the extracted feedback data 143 to determine that an issue occurred on the trip which was related to a passenger's chair on a plane. Accordingly, the trip application 113 could then identify a maintenance remedy service 123 as the appropriate remedy service 123 which corresponds to the passenger's chair issue. In some examples, the trip feedback does not identify an issue for resolution, in which circumstances, the trip application 113 can save the feedback to a data store 126 or send it to another system, service, or application within the network environment 100.

At block 416, the trip application 113 can send feedback data 143 to the remedy service 123. After the trip application 113 has identified a remedy service 123 at block 413, the trip application 113 can send the feedback data 143 extracted at block 409 to the remedy service 123. In some examples, the trip application 113 can send the feedback data 143 based at least in part on receiving the trip feedback at block 406.

At block 419, the remedy service 123 can determine a resolution. Once the remedy service 123 has received the feedback data 143 sent by the trip application 113 at block 416, the remedy service 123 can determine a resolution. The remedy service 123 can analyze the feedback data 143 using natural language processing techniques, or other data analysis techniques to determine the specifics of the issue and a corresponding resolution. In some examples, the remedy service 123 generates a work order for a support team to find a resolution. In such examples, the remedy service 123 can determine when a work order has been resolved.

Next, at block 423, the remedy service 123 can send a resolution confirmation. A resolution confirmation can be representative of a message, notification, or alert which informs the recipient that a resolution has been identified or that a resolution has been implemented. Once the resolution has been determined at block 419, the remedy service 123 can send the resolution confirmation to the trip application 113. In some examples, the remedy service 123 can send the resolution confirmation based at least in part on the feedback data 143 received at block 416. After block 423, the sequence diagram of FIG. 4 comes to an end.

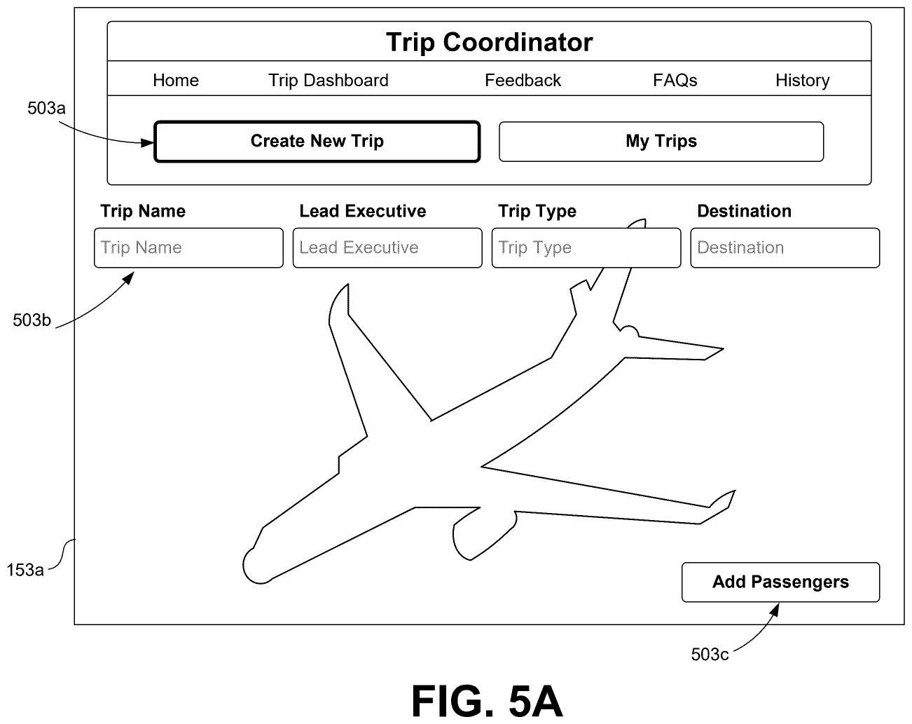

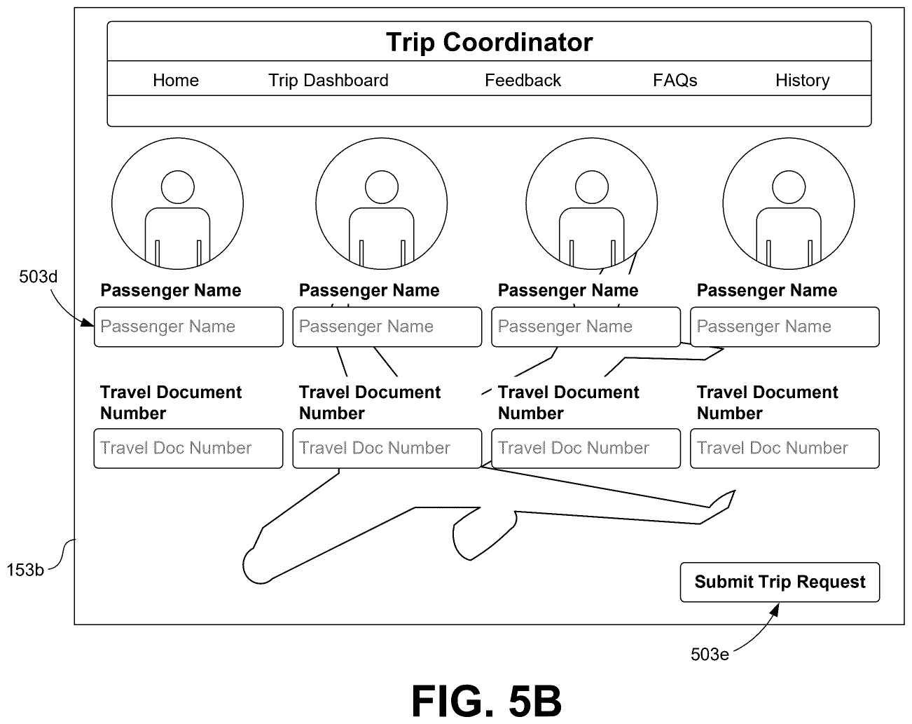

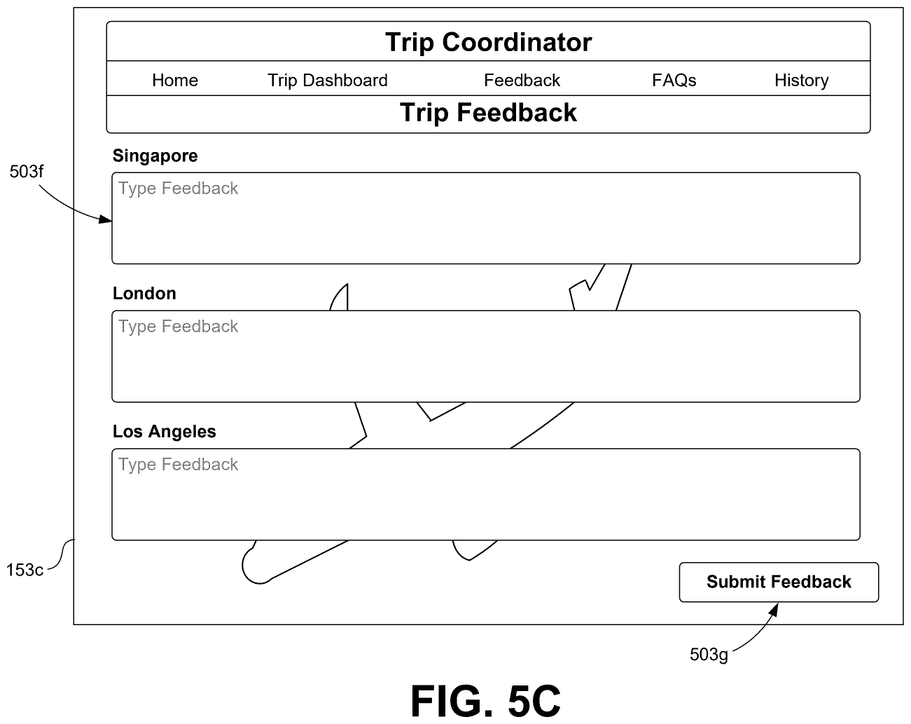

Moving now to FIG. 5A, shown is an example of a user interface 153a depicting a portion of a possible user experience. As discussed in the description of FIG. 1, in some examples, the user interface 153a can be generated by a client application 149 on a client device 106. The user interface 153a can be generated as a web application or a mobile application, or in some other form on the client device 106. The user interface 153a can be used to communicate with the user and to obtain various information about a trip entry. For example, as depicted in FIG. 5A, the user interface 153a can include one or more user interface elements 503 (e.g., 503a, 503b, 503c, etc.) with which a user can interact to create a trip request, view outstanding trip requests, enter information pertaining to a trip request, and navigate to further screens. The user interface 153a of FIG. 5A can include a user interface element 503a which can be used to create a new trip request. This feature can be used to enter a new trip request and can initiate the communications between the client application 149 and the trip application 113, as described in FIGS. 2A, 2B, 3, and 4. Based at least in part on the communications between the trip application 113 and the client application 149, the user interface 153a can communicate various information requests to the user.

As shown in FIG. 5A, the user interface 153a can present a user with one or more user interface elements 503b to enter information such as trip data 133. For example, the client application 149 can cause the user interface 153a to present the user interface elements 503b which correspond to the information necessary for a trip entry. Once the user has input this information via interactions with the user interface elements 503, the client application 149 can send the trip entry to the trip application 113 and initiate the process described in the flowchart of FIGS. 2A and 2B. While FIG. 5A shows user interface elements 503b for entering the trip name, a lead executive, the trip type, and a destination, various other data can be entered as well. In some embodiments, the user interface elements 503b presented in the user interface 153a are based at least in part on communications between the client application 149 and the trip application 113. In some examples, the user interface 153a and corresponding user interface elements 503 can be updated automatically based at least in part on the communications between the client application 149 and other systems, services, or applications in the network environment 100.

Finally, FIG. 5A shows user interface element 503c, an option for the user to navigate to another page. In the example of FIG. 5A, user interface element 503c can be used to navigate to a page where passenger data can be entered. However, according to various examples, the user interface 153a can include one or more user interface elements 503c which navigate to other pages for the collection of additional information about the trip.

Next, FIG. 5B shows an example of a user interface 153b depicting a portion of a possible user experience. The client application 149 can generate user interface 153b in response to receiving interactions with the user interface elements 503 of user interface 153a. For example, when a user interacts with the user interface element 503c, they can be redirected to user interface 153b. The user can interact with user interface element 503d and similar to enter passenger information, such as names and passport numbers as shown in FIG. 5B. According to various examples, the client application 149 can generate user interface 153b along with user interface 153a before initiating the flowchart of FIGS. 2A and 2B. In some examples, the client application 149 generates user interface 153b as part of the prompt for additional data described in the discussion of block 209 of FIG. 2A.

In some examples, the user interface 153b can include additional user interface elements 503 for the user to view different information and enter other information as well. While FIG. 5B depicts availability for entering up to four passengers and their corresponding passport numbers, the user interface 153b can present options for fewer or more passengers to be entered for a trip request. Once a user has added all the passengers for a trip, the user can interact with a user interface element 503e to submit the trip request, or otherwise navigate to another page.

At FIG. 5C, shown is an example of a user interface 153c depicting a portion of a possible user experience. In some examples, the client application 149 can generate user interface 153c as part of a prompt for feedback from the trip application 113 as described in the discussion of blocks 239 and 243 of FIG. 2B, and blocks 400, 403, and 406 of FIG. 4. For example, after a user has returned from a trip, the trip application 113 can communicate with the client application 149 to request feedback from the user. The user interface 153c of FIG. 5C presents a list of completed trips to the user, each trip having a corresponding user interface elements 503f where a user can submit feedback. While FIG. 5C depicts the user interface element 503f as a text box, the user interface element 503f could also comprise a link to a survey or other means for obtaining feedback from the user. The user interface element 503g allows a user to submit their feedback, thereby causing the client application 149 to send the trip feedback to the trip application 113, or otherwise navigate to a new page.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random access portion of the memory and run by the processor, source code that can be expressed in proper format such as object code that is capable of being loaded into a random access portion of the memory and executed by the processor, or source code that can be interpreted by another executable program to generate instructions in a random access portion of the memory to be executed by the processor. An executable program can be stored in any portion or component of the memory, including random access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random access memory (SRAM), dynamic random access memory (DRAM), or magnetic random access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts and sequence diagrams show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowcharts and sequence diagrams show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts and sequence diagrams can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random access memory (RAM) including static random access memory (SRAM) and dynamic random access memory (DRAM), or magnetic random access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment 103.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
a computing device comprising a processor and a memory; and
machine-readable instructions stored in the memory that, when executed by the processor, cause the computing device to at least:
receive a trip entry associated with a user, the trip entry comprising trip data;
generate a trip record based at least in part on the trip entry, the trip record comprising the trip data;
send the trip record to an approval service;
in response to receiving an approval from the approval service, forward the trip record to a booking service; and
modify the trip record based at least in part on booking data provided by the booking service.

2. The system of claim 1, wherein the machine-readable instructions further cause the computing device to at least:
compare the trip data to a compliance list; and
send a prompt for additional trip data based at least in part on a comparison of the trip data to the compliance list.

3. The system of claim 2, wherein the machine-readable instructions further cause the computing device to at least:
receive the additional trip data; and
modify the trip record to include the additional trip data.

4. The system of claim 1, wherein the machine-readable instructions further cause the computing device to at least modify a status associated with the trip record in response to receiving the approval from the approval service.

5. The system of claim 1, wherein the machine-readable instructions further cause the computing device to at least:
determine a departure time based at least in part on the trip record; and
in advance of the departure time, send a trip-preparedness checklist to a user device.

6. The system of claim 1, wherein the machine-readable instructions further cause the computing device to at least:
determine an arrival time based at least in part on the trip record; and
after the arrival time, send a prompt to a user device for trip feedback.

7. The system of claim 6, wherein the machine-readable instructions further cause the computing device to at least:
receive trip feedback from the user device;
extract feedback data from the trip feedback based at least in part on natural language processing techniques; and
send the trip feedback to a remedy service based at least in part on the feedback data.

8. A method, comprising:
receiving, by a computing device, a trip entry associated with a user, the trip entry comprising trip data;
generating, by the computing device, a trip record based at least in part on the trip entry, the trip record comprising the trip data;
sending, by the computing device, the trip record to an approval service;
in response to receiving an approval from the approval service, forwarding, by the computing device, the trip record to a booking service; and
modifying, by the computing device, the trip record based at least in part on booking data provided by the booking service.

9. The method of claim 8, further comprising:
comparing, by the computing device, the trip data to a compliance list; and
sending, by the computing device, a prompt for additional trip data based at least in part on comparing the trip data to the compliance list.

10. The method of claim 9, further comprising:
receiving, by the computing device, the additional trip data; and
modifying, by the computing device, the trip record to include the additional trip data.

11. The method of claim 8, further comprising modifying, by the computing device, a status associated with the trip record in response to receiving the approval from the approval service.

12. The method of claim 8, further comprising:
determining, by the computing device, a departure time based at least in part on the trip record; and
in advance of the departure time, sending, by the computing device, a trip-preparedness checklist to a user device.

13. The method of claim 8, further comprising:
determining, by the computing device, an arrival time based at least in part on the trip record; and
after the arrival time, sending, by the computing device, a prompt to a user device for trip feedback.

14. The method of claim 13, further comprising:
receiving, by the computing device, trip feedback from the user device;
extracting, by the computing device, feedback data from the trip feedback based at least in part on natural language processing techniques; and
sending, by the computing device, the trip feedback to a remedy service based at least in part on the feedback data.

15. A system, comprising:
a computing device comprising a processor and a memory; and
machine-readable instructions stored in the memory that, when executed by the processor, cause the computing device to at least:
generate a trip record comprising trip data;
identify additional data based at least in part on a compliance list;
send a prompt for the additional data;
receive the additional data;
modify the trip record based at least in part on the additional data; and
send the trip record to an approval service.

16. The system of claim 15, wherein the machine-readable instructions, when executed by the processor, further cause the computing device to at least:
receive approval for the trip record from the approval service; and
modify a status of the trip record based at least in part on the approval.

17. The system of claim 16, wherein the machine-readable instructions, when executed by the processor, further cause the computing device to at least:
in response to receipt of the approval, forward the trip record to a booking service;
receive booking data from the booking service; and
modify the trip record based at least in part on the booking data.

18. The system of claim 15, wherein the machine-readable instructions, when executed by the processor, further cause the computing device to at least:
determine a departure time based at least in part on the trip record; and
in advance of the departure time, send a trip-preparedness checklist to a user device.

19. The system of claim 15, wherein the machine-readable instructions, when executed by the processor, further cause the computing device to at least:
determine an arrival time based at least in part on the trip record; and
after the arrival time, send a prompt to a user device for trip feedback.

20. The system of claim 15, wherein the machine-readable instructions, when executed by the processor, further cause the computing device to at least:
receive trip feedback from a user device;
extract feedback data from the trip feedback based at least in part on natural language processing techniques; and
send the trip feedback to a remedy service based at least in part on the feedback data.
